(19) United States
(12) Patent Application Publication
(10) Pub. No.: US 2022/0330500 A1
(43) Pub. Date: Oct. 20, 2022

(54) Modular Hydroponics Gardening Apparatus

(71) Applicant: Jorge Sepulveda, Wichita, KS (US)

(72) Inventor: Jorge Sepulveda, Wichita, KS (US)

(21) Appl. No.: 17/232,692

(22) Filed: Apr. 16, 2021

(51) Int. Cl. A01G 31/02; A01G 7/04

(52) U.S. Cl. CPC A01G 31/02; A01G 7/045

(57) ABSTRACT

A modular hydroponics gardening apparatus for growing plants without soil includes a water pump in communication with a water source for pumping fluid upwardly through a transfer conduit. The water pump and a lower end of the transfer conduit is positioned in a watertight base member. The apparatus includes growth pods arranged radially inside a midsection member that defines spaced apart apertures, each defining an open end in communication with a respective aperture. A plurality of midsection members may be stacked atop one another. A lid assembly is stacked atop the uppermost midsection member, the transfer conduit extending upwardly from the water pump to the lid assembly where water is pumped and rains down into respective growth pods. An ultraviolet light extends about each midsection and is vertically adjustable for shining its light into respective growth pods. With a timed water supply and controllable light emissions, plant growth is maximized.

### BACKGROUND OF THE INVENTION

This invention relates generally to horticulture and, more particularly, to a modular hydroponics gardening apparatus.

Hydroponics is a technique that allows growing plants indoors and without soil. In the traditional farming system, plants depend on soil to obtain all nutrients needed for their growth. By contrast, an indoor hydroponic garden provides all of these nutrients without involving sunlight, soil, extra labor, allowing farmers to benefit from efficiencies and to reap large

produce yields. Some have said that hydroponics is the farming of the future. The benefits of hydroponics are numerous, including that the hydroponics farmer can have total control over the farming environment. For instance, the farmer may control pH, temperature, nutrients given and the timing thereof, lighting conditions and timing, amount and timing of watering, no weed or pest control issues, and the like.

Various devices have been proposed in the art for hydroponics farming. Although presumably effective for their intended purposes, there is still a need for a hydroponics gardening apparatus that is comprehensive, stackable, adjustable, and observable.

Therefore, it would be desirable to have a modular hydroponics gardening apparatus that may be filled with water or connected to a water source acting as a solvent to dissolve the nutrients added and create the nutrient-rich solution, has modular growth pod sections, and a lid assembly to which water may be pumped and from which water may be controllably dispensed onto the growth pods. Further, it would be desirable to have a modular hydroponics gardening apparatus that makes efficient use of space and is fully transparent or partially transparent for easy observation by others.

### SUMMARY OF THE INVENTION

A hydroponics gardening apparatus for growing plants without soil according to the present invention includes a liquid pump in fluid communication with a nutrient rich solution source and operative to pump fluid upwardly through a transfer conduit. The liquid pump and a lower end of the transfer conduit may be positioned in a watertight base member. The apparatus includes a plurality of growth pods radially arranged inside a midsection member that defines a plurality of apertures, each growth pod having an open end in communication with a respective aperture. A plurality of midsection members may be stacked one atop the other. The apparatus includes a lid assembly stacked atop the uppermost midsection member, the transfer conduit extending upwardly from the water pump to the lid assembly where nutrient rich solution is pumped and trickles down onto and into respective growth pods in which plant seeds have been situated. A Light Source (i.e., LED, HPS, metal halide) extends about each midsection and is vertically adjustable for shining light into respective growth pods. With a timed water supply and controllable light emissions, plant growth is maximized.

Therefore, a general object of this invention is to provide a hydroponics gardening apparatus for growing plants without soil.

Another object of this invention is to provide a hydroponics gardening apparatus, as aforesaid, having multiple modules that are stackable atop one another, each midsection member having a plurality of growth pods situated for receiving water and ultraviolet light.

Still another object of this invention is to provide a hydroponics gardening apparatus, as aforesaid, wherein the Light Source is vertically movable so as to adjust a distance or angle relative to the growth pods.

Yet another object of this invention is to provide a hydroponics gardening apparatus, as aforesaid, in which the nutrient rich solution is pumped from a source to a lid assembly from which it is trickled down into the plurality of growth pods.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a modular hydroponics gardening apparatus according to a preferred embodiment of the present invention;

FIG. 2 is an exploded view of the modular hydroponics gardening apparatus as in FIG. 1;

FIG. 3a is a side view of a base member illustrated removed from the modular hydroponics gardening apparatus shown in FIG. 1;

FIG. 3b is a sectional view taken along line 3b-3b of FIG. 3a;

FIG. 3c is an isolated view on an enlarged scale taken from FIG. 3b;

FIG. 4a is a side view illustrated removed from the modular hydroponics gardening apparatus;

FIG. 4b is a sectional view taken along line 4b-4b of FIG. 4a;

FIG. 4c is an isolated view on an enlarged scale taken from FIG. 4a;

FIG. 4d is an isolated view on an enlarged scale taken from FIG. 4b;

FIG. 5a is a side view of the lid member removed from the modular hydroponics gardening apparatus;

FIG. 5b is a sectional view taken along line 5b-5b of FIG. 5a;

FIG. 5c is an isolated view on an enlarged scale taken from FIG. 5b;

FIG. 5d is an isolated view on an enlarged scale taken from FIG. 5b;

FIG. 6a is a side view of the modular hydroponics gardening apparatus shown in FIG. 1, illustrated with the light source in a raised configuration;

FIG. 6b is a sectional view taken along line 6b-6b taken from FIG. 6a;

FIG. 6c is a side view of the modular hydroponics gardening apparatus shown in FIG. 1, illustrated with the light source in a lowered configuration;

FIG. 7a is a top perspective view of a light source removed from the modular hydroponics gardening apparatus as in FIG. 1;

FIG. 7b is a top perspective view of a light source removed from the modular hydroponics gardening apparatus as in FIG. 1;

FIG. 8a is a side view of the light source as in FIG. 7a;

FIG. 8b is a sectional view taken along line 8b-8b as in FIG. 8a;

FIG. 8c is an isolated view on an enlarged scale taken from FIG. 8b;

FIG. 9a is a side view of the lid member according to another embodiment of the present invention;

FIG. 9b is a sectional view taken along line 9b-9b as in FIG. 9a; and

FIG. 9c is an isolated view on an enlarged scale taken from FIG. 9b.

### DESCRIPTION OF THE PREFERRED EMBODIMENT

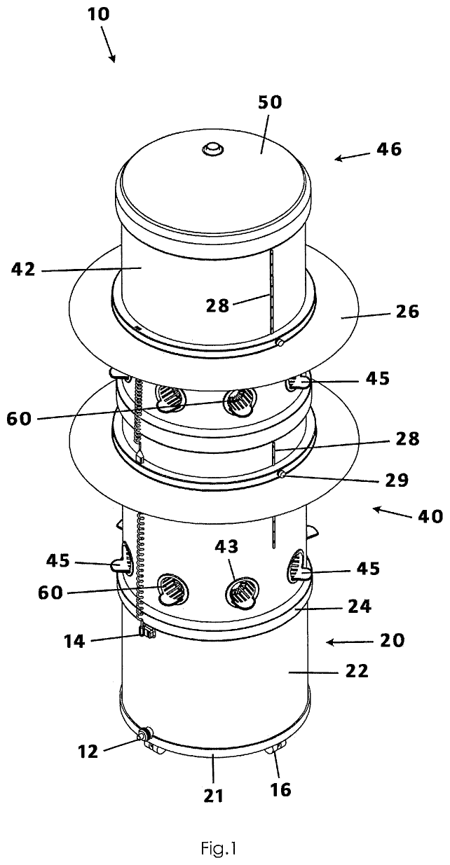

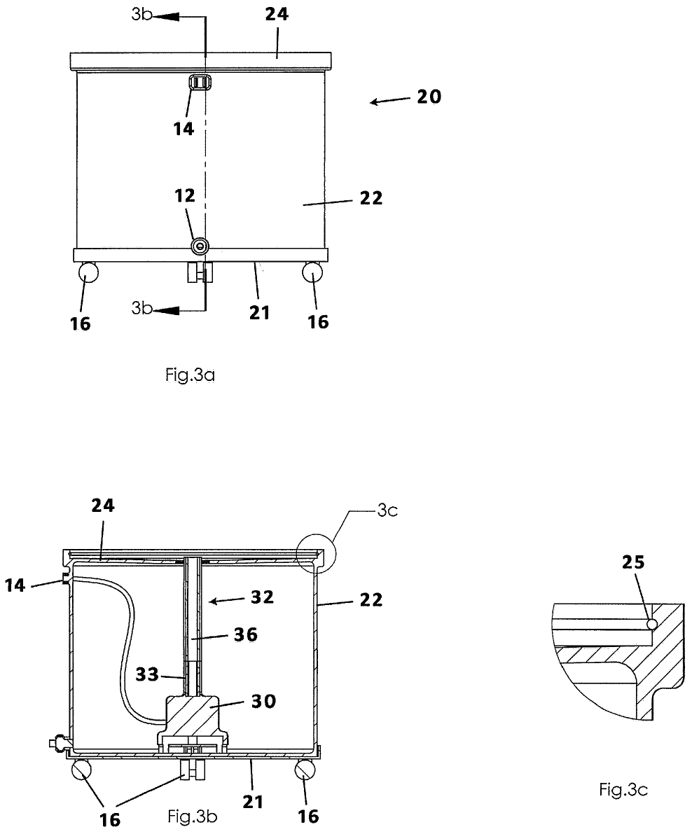

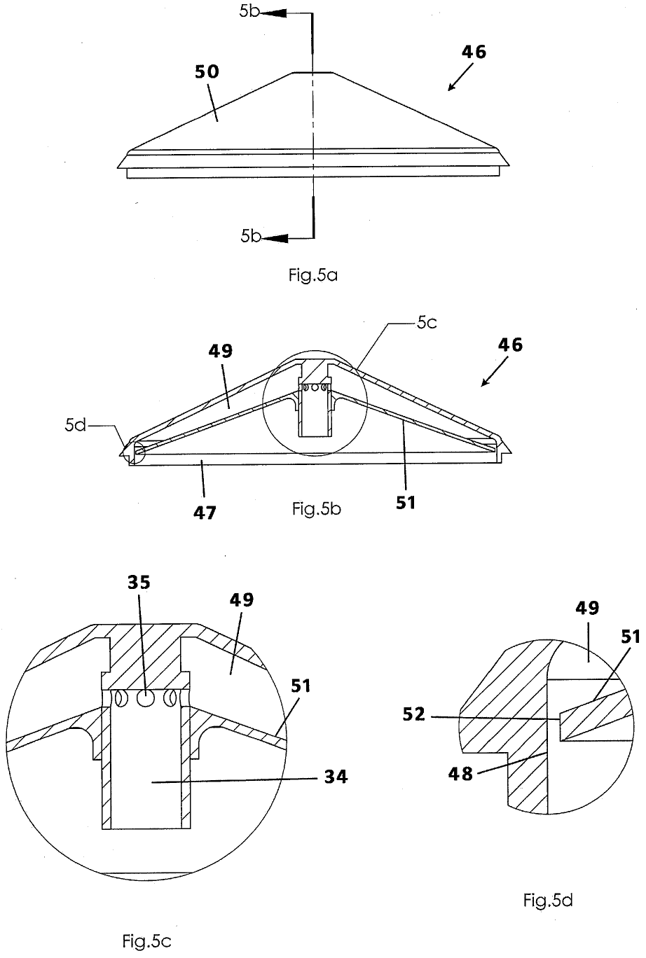

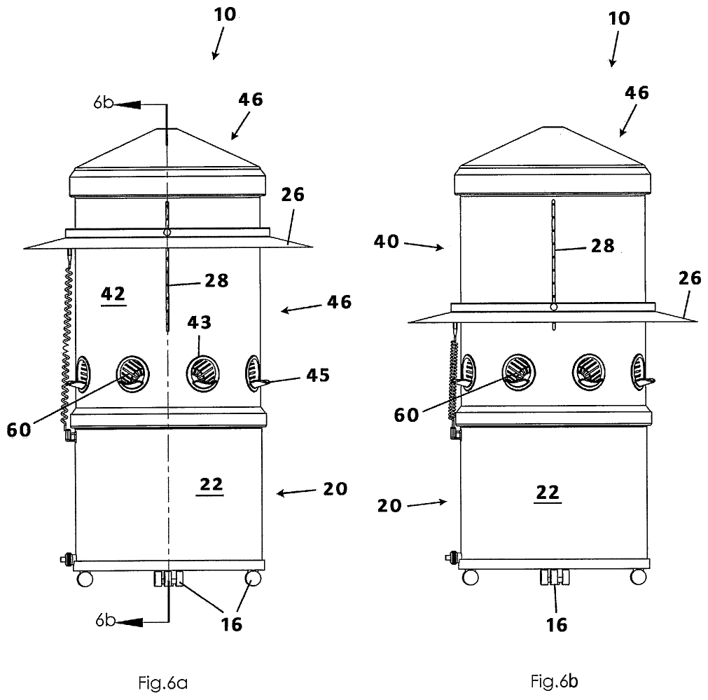

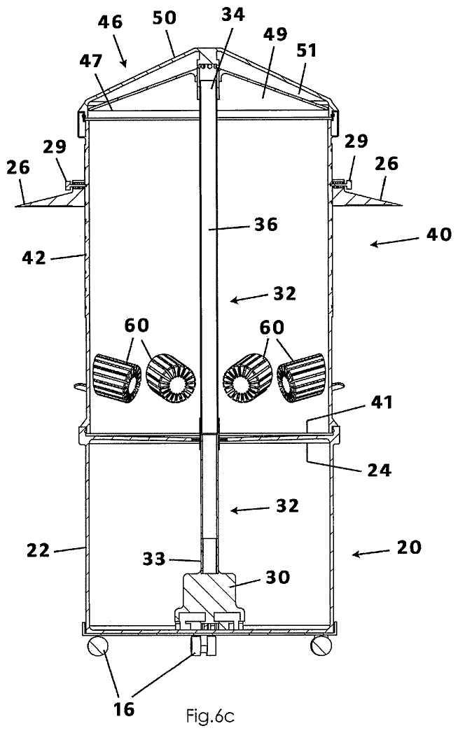

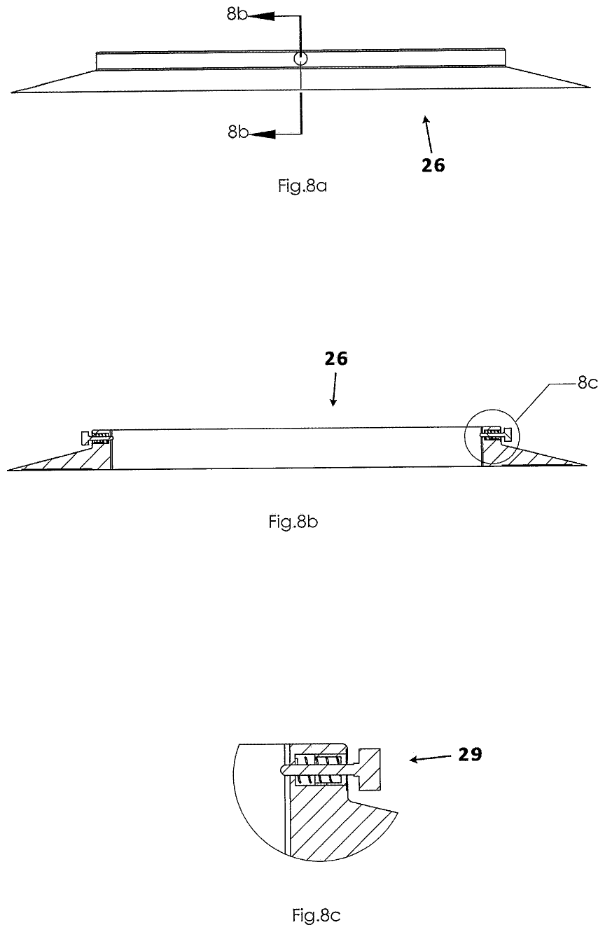

A modular hydroponics gardening apparatus according to a preferred embodiment of the present invention will now be described with reference to FIGS. 1 to 9c of the accompanying drawings. The modular hydroponics gardening apparatus 10 includes a water pump 30, a transfer conduit 32, a baffle 51 or sprinkler head 53, at light source 26, and a plurality of growth pods 60 arranged together for growing plants in the absence of soil.

Preferably, the modular hydroponics gardening apparatus 10 includes multiple stackable containers suitable for securing various components of the hydroponics gardening system and these modular containers will be described below in due course. It is understood, however, that the components of the present apparatus may be arranged and coupled to a framework that is different from the stackable containers shown in the accompanying illustrations. Accordingly, a hydroponics gardening apparatus 10 will be described in general terms apart from the modular housings configured to contain various components.

First, the hydroponics gardening apparatus 10 includes a liquid pump 30 in fluid communication with a nutrient rich solution source, the liquid pump 30 being operable to pump a fluid received from the nutrient rich solution source 12. The nutrient rich solution source 12 may include a residential or commercial water line or may refer to water deposited into a base member 20 with nutrients added as will be described later

Further, the hydroponics gardening apparatus 10 may include a transfer conduit 32 having a lower end 33 coupled to and in fluid communication with the water pump 30 and having an upper end 34 opposite the lower end 33. The transfer conduit 32 includes a body portion 36 extending between the lower end 33 and upper end 34 and has an elongate and tubular configuration. The lower end 33 and upper end 34 have an open configuration such that water (or other fluid) may be pumped upwardly from the water pump 30 to the upper end 34 when the water pump 30 is energized. The water pump 30 may be selectively energized with electricity supplied through a power cord via a USB port 14. It is understood that several iterations of the transfer conduit 32 may be coupled together so as to extend upwardly through multiple housings as will be described below.

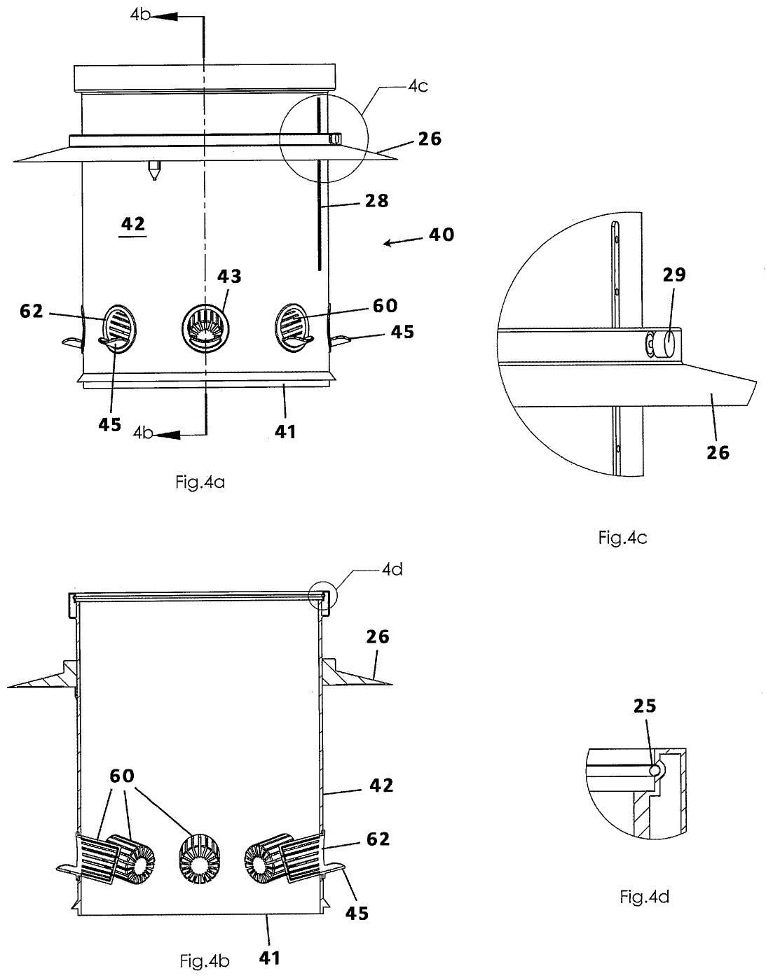

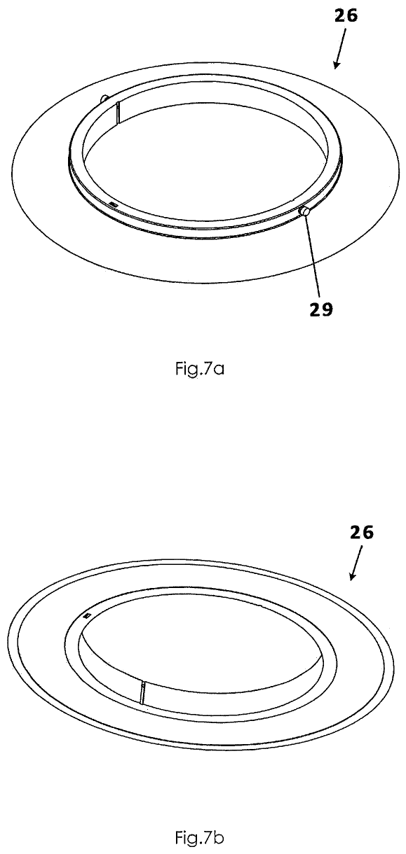

Further, the hydroponics gardening apparatus 10 may include a plurality of growth pods 60 spaced apart from one another in a radial pattern. Preferably, each growth pod 60 includes an end wall and a continuous sidewall connected to the end wall and defining an open end 62 opposite the end wall (FIGS. 4c and 7). In an embodiment, the end wall and continuous sidewall of each growth pod 60 may be perforated or otherwise permeable so as to allow water into an interior space defined by the walls. The perforated construction also enables water to exit a respective growth pod 60, such as if an excessive volume of water is accumulated in the respective growth pod 60.

Still further, the hydroponics gardening apparatus 10 may include a fluid distribution baffle 51 in fluid communication with the upper end 34 of transfer conduit 32. Preferably, the plurality of growth pods 60 is positioned intermediate the water pump 30 and baffle 51, the baffle 51 being in fluid communication with the upper end 34 of the transfer conduit 32. Fluid distribution baffle 51 may include a floor that slopes downwardly from the upper end 34 of the transfer conduit 32 a free end 52 from which the pumped fluid from the transfer conduit 32 naturally falls downwardly by the force of gravity. It is understood that the open end 62 of each growth pod 60 may be aligned with the free end 52 of the fluid distribution baffle 51 such that a predetermined amount or rate of falling pumped fluid is received into the interior space of each respective growth pod 60. Other structures and variations for directing the pumped fluid into respective growth pods 60 will be discussed later.

Now that the essential components of the hydroponics gardening apparatus 10 have been introduced, a more detailed description of a preferred embodiment will be disclosed. First, the modular hydroponics gardening apparatus 10 may include a first housing that will be referred to as a base member 20, the base member 20 having a bottom wall 21, a continuous sidewall 22 extending upwardly from a peripheral edge of the bottom wall 21, and a top wall 24 that is opposite, displaced, and parallel to the bottom wall 21. Together, these walls cooperatively define an interior area. Preferably, the base member 20 may include at least one rubber seal, such as an O-ring 25 so that the interior area is made watertight. In an embodiment, water or a water-fertilizer combination may be deposited into the watertight interior area of the base member 20 and, as such, provides the water source referred to above. Preferably, the water pump 30 is positioned within the interior area of the base member 20 and is in fluid communication with the water source whether the water source is a residential or commercial water pipe or is the quantity of water inside the interior area of the base member 20. In a related aspect, a plurality of wheels 16 may be coupled to an underside of the base member 20 so that the base member and entire apparatus 10 of modular components may be moved around and portable. Preferably, the wheels 16 are caster wheels.

Further, the lower end 33 of the transfer conduit 32 is coupled to and in fluid communication with the water pump 30 and the body portion 36 of the transfer conduit 32 extends upwardly and away from the water pump 30 such that fluid pumped by the water pump 30 is transferred to the upper end 34 where it may be dispensed to the plurality of growth pods 60 in the manner to be described later. Again, multiple transfer conduits may be coupled to one another in series using a standard plumbing flange in such cases where multiple layers of growth pods 60 are stacked in a modular manner.

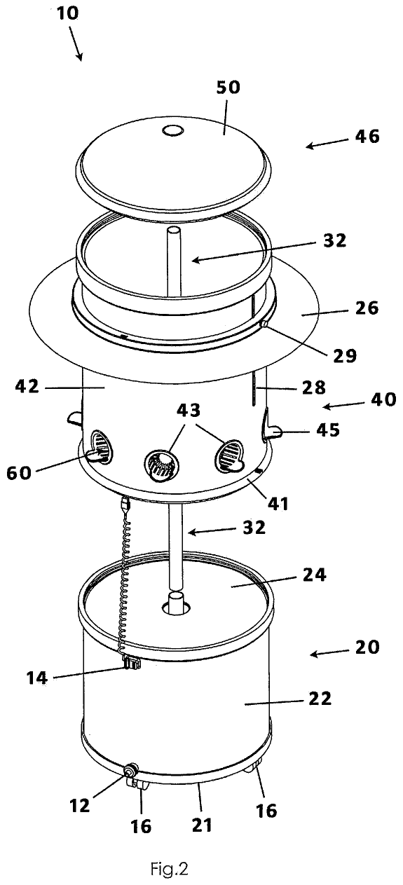

Further, the modular hydroponics gardening apparatus 10 includes at least one midsection member 40 and, preferably, a plurality of midsection members 40 that are configured for stacking one top another in a modular configuration. More particularly each midsection member 40 may include a lower wall 41 and a continuous midsection sidewall 42 extending upwardly from a peripheral edge of the lower wall 41. The lower wall 41 and continuous midsection sidewall 42, together, define an interior space and an open top (FIG. 2). In an embodiment, the plurality of growth pods 60 are positioned in the interior space of a respective midsection member 40. The continuous midsection sidewall 42 defines a plurality of apertures 43, each aperture 43 being spaced apart from any adjacent aperture 43 and defining a diameter that is associated with and complementary to an open end 62 of a growth pod 60, respectively. In other words, the plurality of growth pods 60 are arranged in a radial pattern that matches the pattern or distribution of the plurality of apertures 43 defined by the continuous midsection sidewall 42 of a midsection member 40. Preferably, the midsection member 20 may include at least one rubber seal, such as an O-ring 25 so that the interior area is made watertight.

With further reference to FIG. 4A, each growth pod 60 may have a tubular configuration and may be tilted upwardly toward an associated aperture 43 such that water collected from outside said continuous midsection sidewall 42 (i.e., falling from said free end 52 of said fluid distribution baffle 51) will flow into the interior space of the respective growth pod 60. In addition, each growth pod 60 may include or be associated with a collection member 45 that may be coupled to and extending away from an exterior surface of a respective continuous midsection sidewall 42. Each collection member 45 has a configuration for receiving (such as a cupped configuration) or deflecting falling water through a respective aperture 43 and into a respective interior space of a respective growth pod 60.

In another aspect, a light source 26 may be mounted to an exterior surface of a respective continuous midsection sidewall 42 in a manner that is slidably movable between a raised configuration adjacent an upper extent of the continuous midsection sidewall 42 and a lowered configuration adjacent a lower extent of the continuous midsection sidewall 42. In an embodiment, the light source is oriented to direct its light rays through the plurality of apertures 43 into the plurality of open ends 62 of the plurality of growth pods 60, respectively. In an embodiment, the light source 26 may have a disk-shaped configuration that is complementary to the cylindrical shape of a respective continuous midsection sidewall 42 and may be mounted for movement along a track 28 between raised and lowered configurations. Further, the light source 26 may be energized by electrical power supplied by an appropriate USB port 14 and cord as would be understood by one of ordinary skill. The light source disk may include a spring-loaded release button 29 in communication with the track 28 and is operable to normally hold the light source 26 at a selected vertical position or to be manipulated (such as by pulling it outwardly) to allow the light source 26 to move up or down along the track 28. (FIG. 4c). Moving the light source 26 relative to the growth pods 60 may be done to maximize growth of plants.

As mentioned previously, at least one midsection member 40 may actually include a plurality of midsection members 40 each having an identical construction and being

stackable atop one another. With further regard to connectivity, a lower edge of a lowermost continuous midsection sidewall 42 may be coupled to the top wall of the base member 20. Similarly, an upper edge of a continuous midsection sidewall 42 may be coupled to a lower edge of a continuous midsection sidewall 42 of a next upwardly modular midsection member 40 as shown in the accompanying illustrations. In other words, all of the outer structures of the modules described herein are complementary to one another so that the housings are modularly coupled together.

Further, the modular hydroponics gardening apparatus 10 includes a lid assembly 46. In an embodiment, the lid assembly 46 may include a floor 47 and a continuous side panel 48 extending upwardly from a peripheral edge of the floor 47. As shown, the floor and continuous side panel 48, together, define an interior chamber 49 and an upper edge of the continuous side panel 48 defines an open top. In an embodiment, the lid assembly 46 includes a lid 50 releasably coupled to an upper edge of the continuous side panel 48, said lid 50 covering the open top when mounted atop the continuous side panel 48. Preferably, the transfer conduit 32 or a plurality of transfer conduits 32 are coupled together as described above extends upwardly through the interior area, interior space, and interior chamber (FIG. 7). The upper end 34 of the uppermost transfer conduit 32 is positioned in the interior chamber 49 of the lid assembly 46. A regulator port 35 may be coupled to the upper end 34 and is operable to regulate the speed or volume of pump fluid (i.e., water).

In this embodiment, a fluid distribution baffle 51 is mounted in the interior chamber and is in fluid communication with the upper end 34 of the transfer conduit 32. More particularly, the baffle 51 may include a floor 47 that is angled downwardly (i.e., sloped) between the upper end 34 and a free end 52 such that the pumped fluid is dispensed by the regulator port 35 onto the floor 47 where it runs to the free end 52 and then trickles down an exterior surface of the at least one midsection member 40 and onto respective collection members 45 which then direct collected fluid into respective growth pods 60. Stated another way, the plurality of apertures 43 defined by the continuous midsection sidewall 42 are in alignment with the free end 52 of the baffle 51 for collecting the trickling fluid. It will be understood that a diameter of the continuous side panel 48 of the lid assembly 46 may be slightly greater than a diameter of the at least one continuous midsection sidewall 42 such that said free end 52 of the baffle 51 may extend outwardly towards the exterior surface of the continuous midsection sidewall 42 on which to then trickle down in a laminar fashion.

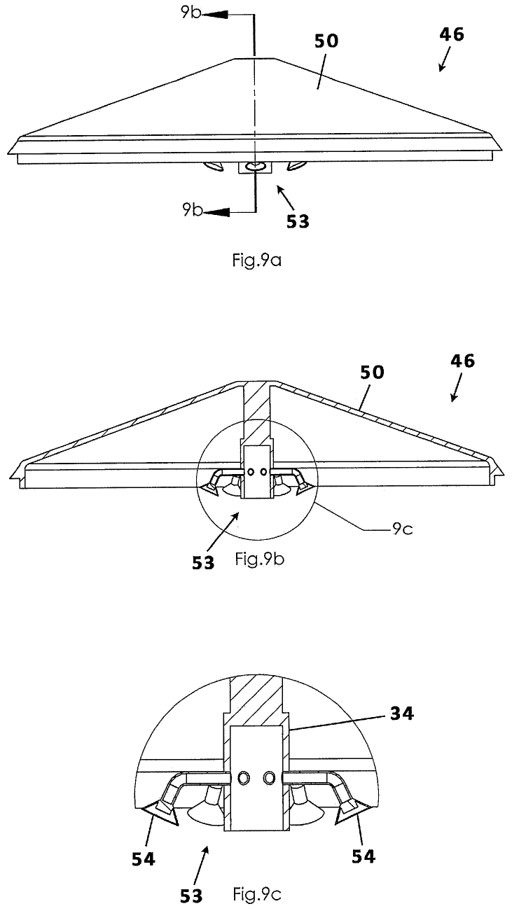

In another embodiment, the lid assembly 46 may include only a lid 50 coupled atop the uppermost midsection member 40 without the floor and sidewall described previously. In this embodiment, the lid assembly 46 may include a sprinkler head 53 coupled to the upper end 34 of the transfer conduit 32, the sprinkler head 53 having a plurality of sprinklers 54 arranged in a radial pattern (FIG. 9c). In this embodiment, the pumped fluid may be dispensed by the plurality of sprinklers 54 such that the distributed fluid falls via gravity directly onto the growth pods 60, the growth pods 60 being perforated such that dispensed water immediately permeates each growth pod, respectively.

It is a critical aspect to the present invention that the owner of the modular hydroponics gardening apparatus 10 and persons authorized thereby be able to observe operation of the garden and the enhanced plant growth anticipated thereby. Accordingly, walls of at least one midsection member 40 and of the lid assembly 46 are constructed of a transparent material. For instance, the walls may be constructed of Plexiglas®, transparent plastic, saran plastic wrap (Polyvinylidene Chloride), or the like. Being able to observe circulation of the nutrient rich solution, root growth/health, transfer conduit, and watering better enables the observer to adjust and regulate the components.

In use, seeds of the plants that are intended to be grown using the modular hydroponics gardening apparatus 10 may be inserted into a germination medium such as rockwool and into the plurality of growth pods 60 through respective apertures 43. Further, the base member 20 may be filled with water or water with nutrients or the liquid pump may be connected to another water line or the like. It is observed that by filling the base member with water and powering electrical components via USB ports, the modular hydroponics gardening apparatus 10 is truly portable. Then, the base member 20 may be coupled to the at least one or multiple midsection members 40 and lid assembly 46 as discussed above. Operation of the water pump 30 may be energized, adjustment of the light source 26 may be energized to move slidably along the track, and the overall operation and health of the plants may be observed through the transparent construction.

It is understood that while certain forms of this invention have been illustrated and described, it is not limited thereto except insofar as such limitations are included in the following claims and allowable functional equivalents thereof.

1. A hydroponics gardening apparatus for use with a nutrient rich solution source to grow plants, said hydroponics gardening apparatus, comprising:
a liquid pump in fluid communication with the nutrient rich solution source and operative to pump a fluid;
a transfer conduit that includes a lower end in fluid communication with said water pump and an upper end opposite said lower end, said transfer conduit including a body portion having a tubular and elongate configuration extending upwardly from said water pump, said body portion configured to convey said pumped fluid to said upper end;
a fluid distribution baffle in fluid communication with said upper end of said transfer conduit for receiving said pumped fluid, said fluid distribution baffle having a floor that slopes downwardly from said upper end to a free end from which said pumped fluid falls by gravity; and
a plurality of growth pods positioned intermediate said water pump and said baffle, said plurality of growth pods each defining an open end aligned with said free end for receiving said falling pumped fluid.

2. The hydroponics gardening apparatus as in claim 1, further comprising a regulator port positioned at said upper end of said transfer conduit operable to regulate a speed at which said pumped fluid is output onto said baffle.

3. The hydroponics gardening apparatus as in claim 1, further comprising a light source proximate said plurality of growth pods for shining a light towards said plurality of growth pods.

4. The hydroponics gardening apparatus as in claim 3, wherein said light source is an LED, High Pressure Sodium, Metal Halide, or combination thereof.

5. The hydroponics gardening apparatus as in claim 4, wherein said light source has a disk-shaped configuration surrounding said plurality of growth pods.

6. The hydroponics gardening apparatus as in claim 5, further comprising means for adjusting a distance between said light source and said plurality of growth pods.

7. The hydroponics gardening apparatus as in claim 1, further comprising a base member having a bottom wall and a continuous sidewall extending upwardly from a peripheral edge of said bottom wall, said bottom wall and said continuous sidewall, together, defining an interior area, said liquid pump and said lower end of said transfer conduit being situated in said interior space of said base member.

8. The hydroponics gardening apparatus as in claim 7, wherein said base member includes at least one rubber seal and is watertight.

9. The hydroponics gardening apparatus as in claim 7, further comprising at least one midsection member operatively mounted atop said base member and including a lower wall and a continuous midsection sidewall extending upwardly from a peripheral edge of said lower wall, said lower wall and said continuous midsection sidewall, together, defining an interior space and said continuous midsection sidewall defining a plurality of apertures, said plurality of growth pods being situated in said interior space in a radial pattern and each open end is in communication with an associated aperture of said plurality of apertures, respectively.

10. The hydroponics gardening apparatus as in claim 9, wherein said lower wall of said at least one midsection member is coupled to an upper edge of said continuous sidewall of said base member.

11. The hydroponics gardening apparatus as in claim 10, further comprising:
a lid assembly that includes a floor and a continuous side panel extending upwardly from a peripheral edge of said floor, said floor and said continuous side panel, together, defining an interior chamber and said continuous side panel defining an open top;
wherein said lid assembly includes a lid releasably coupled to an upper edge of said continuous side panel so as to selectively enclose said chamber;
wherein said transfer conduit extends through said interior area, said interior space, and said interior chamber;
wherein said regulator port and said baffle are situated in the said interior chamber of said lid assembly.

12. A modular hydroponics gardening apparatus for use with a nutrient rich solution source to grow plants, said hydroponics gardening apparatus, comprising:
a base member having a bottom wall and a continuous sidewall extending upwardly from a peripheral edge of said bottom wall, said bottom wall and said continuous sidewall together defining an interior area,
a liquid pump situated in said interior area of said base member, said liquid pump being in fluid communication with the nutrient rich solution source and operative to pump a fluid;
a transfer conduit that includes a lower end in fluid communication with said liquid pump and an upper end opposite said lower end, said transfer conduit having a tubular and elongate body portion extending upwardly from said liquid pump, said body portion configured to convey said pumped fluid to said upper end
at least one midsection member having a lower wall operatively mounted atop said base member and having a continuous midsection sidewall extending upwardly from a peripheral edge of said lower wall, said lower wall and said continuous midsection sidewall, together, defining an interior space and said continuous midsection sidewall defining a plurality of apertures,
a plurality of growth pods mounted in a radial pattern and positioned in said interior space of said at least one midsection member, each growth pod defining an open end in communication with an associated aperture of said plurality of apertures, respectively;
a lid assembly operatively mounted atop said at least one midsection member that includes a floor and a continuous side panel extending upwardly from a peripheral edge of said floor, said floor and said continuous side panel, together, defining an interior chamber and said continuous side panel defining an open top;
wherein said transfer conduit extends through said interior area, said interior space, and said interior chamber, said upper end being situated in said interior chamber;
a fluid distribution baffle positioned in said interior chamber in fluid communication with said upper end of said transfer conduit for receiving said pumped fluid, said fluid distribution baffle having a floor that slopes downwardly from said upper end to a free end from which said pumped fluid falls by gravity.

13. The modular hydroponics gardening apparatus as in claim 12, wherein said lid assembly includes a lid releasably coupled to an upper edge of said continuous side panel so as to selectively enclose said interior chamber.

14. The modular hydroponics gardening apparatus as in claim 12, wherein open ends of said plurality of growth pods are aligned with said free end for receiving said falling pumped fluid.

15. The modular hydroponics gardening apparatus as in claim 12, further comprising a regulator port positioned at said upper end of said transfer conduit for regulating a speed at which said pumped fluid is output onto said baffle.

16. The modular hydroponics gardening apparatus as in claim 12, further comprising a light source mounted to an exterior surface of said continuous midsection sidewall, said light source being slidably movable between a raised configuration and a lowered configuration and being oriented to direct a light upon said plurality of apertures.

17. The modular hydroponics gardening apparatus as in claim 16, wherein said light source is an LED, HPS, Metal Halide or combination thereof.

18. The modular hydroponics gardening apparatus as in claim 17, wherein said light source has a disk-shaped configuration surrounding said exterior surface of said continuous midsection sidewall.

19. The modular hydroponics gardening apparatus as in claim 12, wherein said base member includes at least one rubber seal and is watertight.

20. The modular hydroponics gardening apparatus as in claim 12, wherein:
said plurality of growth pods each has a tubular configuration and is tilted upwardly toward an associated aperture; and
said plurality of growth pods each includes a collection member extending outwardly from said continuous sidewall and having a cupped configuration for collecting the fluid falling from said free end of said baffle and positioned so as to direct said collected fluid into an open interior of an associated growth pod.

21. The modular hydroponics gardening apparatus as in claim 15, wherein said regulator port includes a sprinkler head having a plurality of sprinklers in fluid communication with said upper end of said transfer conduit for dispensing the pumped fluid into said interior space of said at least one midsection member.

22. The modular hydroponics gardening apparatus as in claim 21, wherein each growth pod includes a continuous sidewall that is perforated so as to allow the dispensed pumped fluid into the open interior.

23. The modular hydroponics gardening apparatus as in claim 12, wherein said at least one midsection member is a plurality of midsection members stackable one atop another.

24. The modular hydroponics gardening apparatus as in claim 12, wherein said continuous sidewall, said continuous midsection sidewall, and said lid assembly are constructed of a transparent material.
